(19) United States
(12) Patent Application Publication
(10) Pub. No.: US 2026/0212202 A1
(43) Pub. Date: Jul. 23, 2026

(54) CLASSIFIER CONVERSION SYSTEM

(71) Applicant: Bank of America Corporation, Charlotte, NC (US)

(72) Inventors: Giri Prakash Annamalai, Monroe, NC (US); Prejish Thomas, Prosper, TX (US); Priyank R. Shah, Plano, TX (US)

(21) Appl. No.: 19/035,099

(22) Filed: Jan. 23, 2025

(51) Int. Cl. G06N 3/096

(52) U.S. Cl. CPC G06N 3/096

(57) ABSTRACT

A system for converting a classifier model application into a large language model (“LLM”) application is provided. The system may include a preprocessing process and a real-time process. The preprocessing process may retrieve tables comprising intents and entities from a database, convert each of the tables into vectorized records and transmit the records to the LLM application. The real-time process may receive a question and convert the question into a vector. The real-time process may execute vector similarity search(es) to identify a plurality of records that match the question vector. The real-time process may reduce noise in the plurality of records. The real-time process may create a prompt, comprising the plurality of records; and input the prompt to an LLM within the LLM application. The real-time process may receive a selection, from the LLM, of a record. The real-time process may transmit the selected record to the user.

### FIELD OF TECHNOLOGY

Aspects of the disclosure relate to machine learning models.

### BACKGROUND OF THE DISCLOSURE

The current state of the art of machine learning models involves entities managing multiple user-facing technology applications. The user-facing technology applications interact with users to provide the users with answers to questions or respond to requests for information.

Most of the current user-facing technology applications are based on classifier models. Classifier models are machine learning models that predict a class label based on input data. Classifier models are trained on a labeled training data set. The training data set is typically limited. As such, machine learning models trained on limited training data sets typically produce limited results.

Current user-facing technology applications are supported by a backend-trained classifier model that can understand and predict an appropriate intent for user input text data presented in a clear and understandable manner. Once the appropriate intent is identified, the classifier model identifies an appropriate corresponding answer or responsive information to the user input. At times, the backend trained classifier model selects an incorrect intent for the user input. When the backend trained classifier model selects an incorrect intent for the user input, the identified corresponding answer or responsive information does not correspond to the user input.

Current classifier models have multiple defects. Firstly, current classifier models are unable to clearly differentiate between the varied, nuanced intent of multiple user inputs that are similar to one another.

Secondly, current classifier models incur difficulties when deciphering longer user input. Current classifier models typically rely on training data to predict an intent from real-time user input. As such, the limitedness of the classifier models may be exacerbated when the user presents a longer, less direct and usually less common input.

The following example may show the distinction between a longer, less direct input versus a shorter, on-point input. A user presents the following question: “Hey, I am a parent of a daughter in school XYZ, and I want to send my daughter some money and I want it to be immediate.” (a longer, less direct input) versus the user presenting the following question: “How can I perform a transfer?” (a shorter, on-point input). When the user presents the input as a longer, less direct input, the user may have presented the input in a manner which is too descriptive for the classifier model to accurately predict the intent. Current classifier models are not skilled for such descriptive and unique input.

Furthermore, a training data set, powering a classifier model, is continually updated based on failures identified within the user-facing technology applications. Each time the training data is updated, the classifier model requires tuning. Classifier model tuning is a difficult, drawn-out, manual process and involves a cycle of tuning classifier model components and classifier model parameters until the classifier model operates at a favorable performance level with a well-adjusted parameter set. As such, it is desirable to minimize changes made to the training data set in order to minimize resources expended during classifier model tuning.

Large language models (“LLMs”) are machine learning models designed for natural language processing tasks. LLMs include artificial neural networks that enable efficient processing and generation of text data. LLMs are trained on large amounts of continually updated text data. The data used to train the LLMs may or may not be labeled data. LLMs do not involve the above-mentioned deficiencies of current classifier models. LLMs are automatically and continually updated, without manual intervention, in response to updates made to training data. As such, LLMs do not require the same tuning frequency as classifier models.

A large amount of computing resources and manual intervention is typically required to migrate classifier models to LLMs. Therefore, migrating classifier models to LLMs is typically a resource consumptive process.

It would be desirable to provide a system and method that involves minimal configuration change and enables an application to migrate from a classifier model-based application to an LLM-based application.

### SUMMARY OF THE DISCLOSURE

Systems, apparatus and methods for migrating a classifier model-based application to an LLM-based application are provided.

Classifier models are trained on training data sets. Training data sets may be stored at training databases associated with, included within and/or linked to the classifier model. Training databases may also be referred to as existing training databases. Training data sets may be specific to an entity. As such, training data sets lack a varied breadth of knowledge because the entity retrieves or generates the training data sets from one or more limited locations that the entity has permission to access. As such, the training data does not encompass a wide viewing range relating to different variations of training data.

Training data sets may be specific to an entity. As such, a financial entity may have a training data set specific to questions relating to financials. For example, a financial entity may have training data relating to user questions and the corresponding intents (intent of the user questions, which may be selected from a plurality of intents), the corresponding entities (subject(s) of the intent, which may be selected from a plurality of entities) and the corresponding concept (category of the intent, which may be selected from a plurality of concepts).

Training data sets may be partitioned into secondary training data sets. Each secondary data set may correspond to a single predefined intent. In an example, a secondary training data set relating to financial data may include a secondary data set corresponding to the single predefined financial intent. The single predefined intent may be termed transfer. The transfer intent secondary training data set may include varied terminology, including multiple permutations and combinations, for performing a transfer of funds. Examples of the terminology may include transfer ten dollars from a checking account and transfer ten dollars to my checking account from a specific person.

To convert a classifier model-based application to an LLM-based application, the training data included in the classifier model may be transferred to the LLM-based application. The training data may be processed prior to being transferred to the LLM-based application. The training data may be processed upon receipt at the LLM-based application. The training data may be processed prior to being transferred to the LLM-based application and/or upon receipt at the LLM-based application.

The training data included in the classifier model-based application may be sent to an intent and/or entity extraction module within the classifier model-based application and/or the LLM-based application. The intent and/or entity extraction module may extract one or more intents and/or one or more entities from the training data. Upon completion of the intent and/or entity extraction, a subject matter expert may be enabled to add a message to each of the intents and/or entities, such as the transfer intent. At times, a subject matter expert may be enabled to add one or more entities to an intent.

It should be noted that various text permutations may be included within the training data. Examples of permutations of the term ten dollars may include the following: ten dollars, $10.00, 10 dollars and $10.

It should also be noted that concepts, included within the training data, may be used to map an intent to one or more entities. For example, there may be a plurality of intents mapped to the transfer intent. These entities may be related to the transfer intent via one or more concepts.

The LLM-based application may receive the training data associated with a specific intent. At times, the LLM-based application may generate a vector for a specific intent; the vector may consider and/or include all, or a portion of, the training data previously linked to the specific intent. The LLM-based application may generate a vector for each intent. Each vector may consider and/or include all, or a portion of, the training data previously linked to the intent.

Intent records, entity records and concept records may each be converted to vectors. In the LLM-based application, there may be an intent table. The intent table may store vectorized intent records. In the LLM-based application, there may be an entity table, the entity table may store vectorized entity records. In the LLM-based application, there may be a concept table. The concept table may store vectorized concept records. There may be mapping between vectorized intent records and vectorized entity records. The mapping may be based on matching concepts. As such, the vectorized intent records, vectorized entity records and vectorized concept records may be mapped to each other.

It should be noted that the LLM-based application may be capable of adding intents, entities and/or concepts based on continuous learning that occurs when the LLM-based application interacts with users and/or when updates are made to the language corpus on which the LLM is based.

The system may include an offline process. The offline process may include pinging the existing training data by retrieving each of the existing tables and converting each table and/or each record within each table, into a vectorized record. The offline process may include inputting each vectorized record into a database associated with, and/or linked to, the LLM-based application.

The system may include an online process (also referred to herein as a real-time process). The online process may include receiving an electronically transmitted a question from a user. The online process may include the system converting the question into a vector. For the purposes of this application, a question converted to a vector may be referred to as a question vector to differentiate between the vectors previously generated by the training data.

The online process may include comparing the question vector to all of the vectors stored in the database associated with, and/or linked to, the LLM-based application. As such the question vector (“Qvs”) may be compared, using a vector similarity search, to vector 1 through vector N (last vector) included in the database associated with, and/or linked to, the LLM-based application. In certain embodiments, the database associated with the LLM-based application may not be an LLM. The online process may include, based on the comparison, finding, or identifying, one or more stored vectors that are a closest match to the question vector.

It should be noted that a vector similarity search (“VSS”) may compare the question vector to vectors stored within the LLM-based application. The VSS may obtain and/or extract stored vectors that are most similar, over a threshold level of similarity, to the vector corresponding to the user question. The VSS may extract a predetermined number of intent results from the stored vectors. The VSS may extract a predetermined number of entity results from the stored vectors. The VSS may extract a predetermined number of concept results from the stored vectors. Multiple VSSs may be executed to identify intent results, entity results and concept results from the stored vectors. The predetermined number may be five or any other suitable predetermined number.

It should be noted that concept results may or may not be included in the identified results of the VSS. At times, the concept results may be used to create a mapping between the identified intents and the identified entities. Additionally, because each entity may be associated with an intent, when an entity is identified, the associated intents may be included in the identified results.

A VSS may be based on a model that is based on a neural network. Both the model and the neural network are based on large numbers of linked neurons which are used to understand the question based on the training data in addition to a language corpus.

The online process may include noise reduction. The noise reduction process may reduce the number of identified intent results, entity results and/or concept results included in the results provided by the one or more VSS processes. With the use of concept matching, the online processes may reduce the noise within the top predetermined number of intents, such as, for example, five intents. Based on the training data input into the LLM-based application, the online process may understand which entity maps to which intent based on concepts referenced by both the intents and/or the intents. The online process may identify a top intent and a top entity for the user question.

In an example, the online process may identify four possible intents and associated entities (also referred to as relevant entities) for each of the intents. The online process may remove an intent and associated that does belong based on concept matching (not via vectorization). In such an example, entity matches may be identified between multiple intents. As such, one or more of the intents and associated entities may be removed from a list of possible intents and associated entities.

The online process may include providing an LLM with a plurality of parameters, including the remaining possible intents and corresponding entities, examples for each of the remaining possible intents and corresponding entities, the text of the user question and a set of natural language instruction, to enable the LLM to identify a single intent. The parameters provided to the LLM may be based on a few-shot learning technique. The few-shot learning technique may provide examples to the LLM based on assumptions.

The following includes examples for the few-shot learning technique. For a possible intent of a routing number, the LLM is provided with a sample routing number.

Upon providing the examples to the LLM, the online process may request the LLM to respond with the best matching intent, from the list of intents, for this user. As such, the LLM is requested to predict what is the user's intent for the presented question. The LLM may identify an exact intent for the user question. The LLM may be trained on a huge set of public data so the LLM may be able to appropriately decipher lengthy user input or input data structured in a way that is not included in the specified training data set included in the classifier model. As such, such a system may be able to overcome technical difficulties, including lengthy user input or input data structured in a way that is not included in the specified training data set, associated with classifier-based models, and the LLM-based application may accurately predict user intent to a user question and identify a response to the user question. The user intent and/or the identified response may be electronically transmitted to the user via a graphical user interface, electronic mail, electronic chat or any other suitable method.

There may be a transition flow and an updated flow. The transition flow may include converting the training data to vectors. The transition flow may include inputting the vectors into the database associated with, and/or linked to, the LLM-based application. In some embodiments, the transition flow may be referred to an offline process.

The updated flow may include processing user inputs using the LLM. The updated flow may fail to include the classifier model-based application. In the updated flow, the LLM may replace, in part, the classifier model-based application.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout and in which:

FIG. 1 shows an illustrative diagram in accordance with principles of the disclosure;

FIG. 2 shows another illustrative diagram in accordance with principles of the disclosure;

FIG. 3 shows yet another illustrative diagram in accordance with principles of the disclosure;

FIG. 4 shows an illustrative flow diagram in accordance with principles of the disclosure;

FIG. 5 shows an illustrative diagram in accordance with principles of the disclosure; and

FIG. 6 shows another illustrative diagram in accordance with principles of the disclosure.

### DETAILED DESCRIPTION OF THE DISCLOSURE

Systems, apparatus and methods for converting a classifier model-based application into an LLM-based application are provided.

Methods may include executing a preprocessing process operating on a hardware processor and a hardware memory. The preprocessing process may include retrieving one or more existing tables comprising intents and entities from a database operating a classifier model. The preprocessing process may include converting each of the existing tables into a vectorized record. The preprocessing process may include inputting each vectorized record into a database operating within the LLM-based application.

Methods may include executing a production process operating on the hardware processor and the hardware memory. The production process may be executed in real-time in response to user questions.

The production process may include receiving a question from a user. The production process may include converting the question into a question vector.

The production process may include executing a first vector similarity search on the question vector. The first vector similarity search may compare the question vector to the vectorized records corresponding to intents stored within the database operating within the LLM-based application.

The production process may include selecting a first predetermined number of vectorized records corresponding to intents that are similar, over a first threshold level of similarity, to the question vector. The production process may include generating a list of vectorized records comprising the selected vectorized records. The list may initially be generated as an empty list, or an empty list data structure.

The production process may include executing a second vector similarity search on the question vector. The second vector similarity search may compare the question vector to the vectorized records corresponding to entities stored within the database operating within the LLM-based application.

The production process may include selecting a second predetermined number of vectorized records corresponding to entities that are similar, over a second threshold level of similarity, to the question vector. The production process may include appending the second predetermined number of vectorized records to the list of vectorized records.

The production process may include performing a noise reduction process on the list of vectorized records. The noise reduction process may include concept matching. The noise reduction process may include removing intents and/or entities that do correlate, over a threshold level of correlation, with the remaining intents and/or entities within the list of vectorized records.

The production process may include creating a prompt to be input into an LLM. The prompt may include the list of vectorized records, an example for each vectorized record included in the list of vectorized records, the question and/or a request for a vectorized record that corresponds to an intent. The vectorized record may have a greater level of correspondence to the user question than the remaining vectorized records within the list of vectorized records.

The production process may include inputting the prompt to the LLM. The production process may include receiving, from the LLM, a selection of a vectorized record from the list of vectorized records.

The production process may include identifying an intent and/or entity that corresponds to the selection of the vectorized record. The production process may include generating a response to the question based on the identified intent and/or entity that corresponds to the selection of the vectorized record. The production process may include electronically transmitting the response to the user.

At times, the response may also be based on additional data, such as data relating to the user. An example of a response based on additional data may include when the LLM identifies the intent of a user question to be routing number, the LLM, or other suitable processor, may identify the routing number of the user. As such response transmitted to the user may include: The routing number for your account is 1234567890.

Illustrative method steps may be combined. For example, an illustrative method may include steps shown in connection with another illustrative method.

The steps of methods may be performed in an order other than the order shown or described herein. Embodiments may omit steps shown or described in connection with illustrative methods. Embodiments may include steps that are neither shown nor described in connection with illustrative methods.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

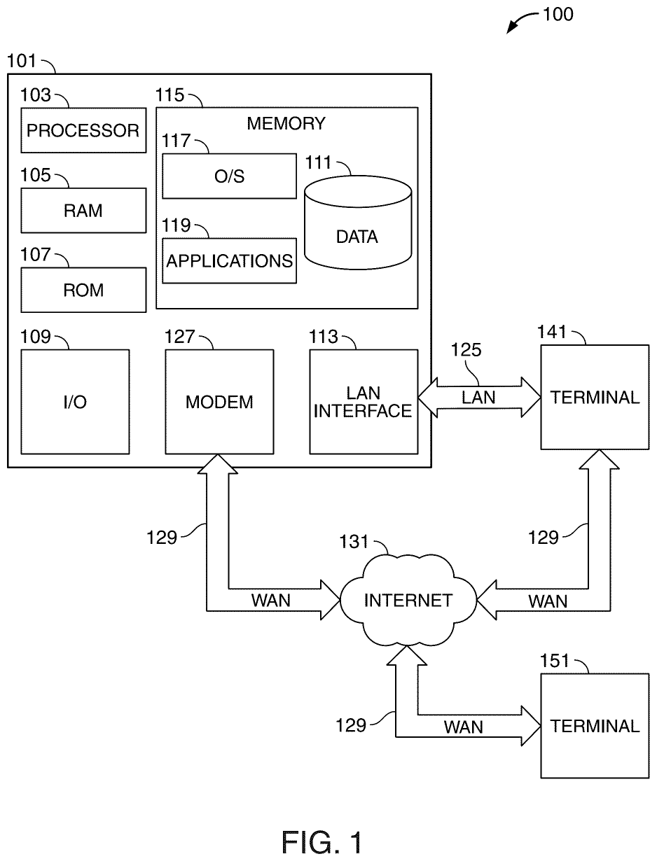

FIG. 1 shows an illustrative block diagram of system 100 that includes computer 101. Computer 101 may alternatively be referred to herein as an “engine,” “server,” or a “computing device.” Computer 101 may be a workstation, desktop, laptop, tablet, smartphone and/or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text and/or audio assistance files. The data stored in memory 115 may also be stored in cache memory and/or any other suitable memory.

I/O module 109 may include connectivity to a microphone, keyboard, touch screen, mouse and/or stylus through which input may be provided into computer 101. The input may include input relating to cursor movement. The input/output module may also include one or more speakers for providing audio output and a video display device for providing textual, audio, audiovisual and/or graphical output. The input and output may be related to computer application functionality.

System 100 may be connected to other systems via a local area network (“LAN”) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include LAN 125 and a wide area network (“WAN”) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory and/or any other suitable memory.

Additionally, application program(s) 119, which may be used by computer 101, may include computer executable instructions for invoking functionality related to communication, such as e-mail, Short Message Service (“SMS”), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

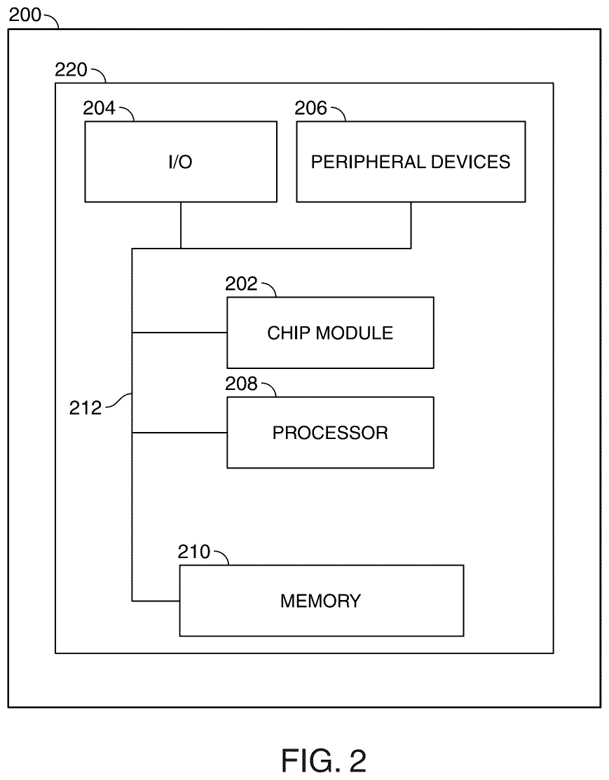

FIG. 2 shows illustrative apparatus 200 that may be configured in accordance with the principles of the disclosure. Apparatus 200 may be a computing device. Apparatus 200 may include one or more features of the apparatus shown in FIG. 1. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

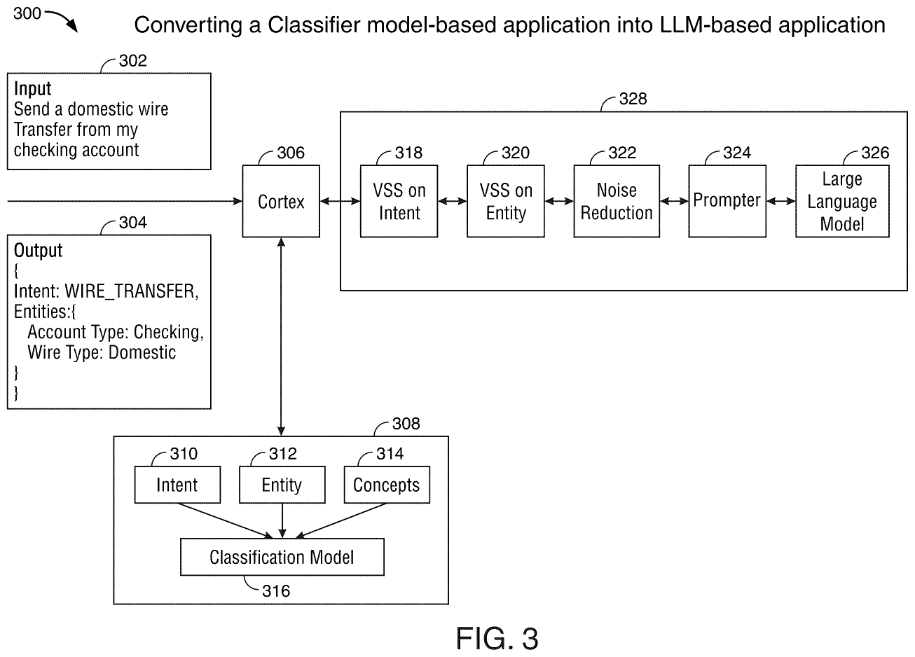

FIG. 3 shows illustrative diagram 300. Diagram 300 shows a process for converting a classifier model-based application to an LLM-based application.

Classifier-based application is shown at 308. Classifier-based application may include classification model 316. Intents 310, entities 312 and concepts 314 may be input and/or included within classification model-based application 308. Each of intents 310, entities 312 and concepts 314 may be stored as tables within classifier-based application 308. It should be noted that, in some embodiments, each table may correspond to a single intent, entity or concept.

Classifier-based application 308 may communicate electronically with cortex 306. Cortex 306 may be a processor. Cortex 306 may include one or more natural language processing capabilities. Cortex 306 may include conversion capabilities. Cortex 306 may be able to convert tables into vectorized records.

Cortex 306 may also be user-facing. As such, cortex 306 may receive questions from a user. Cortex 306 may respond to the questions received from the user. Cortex 306 may be configured to electronically communicate with classification model 316 to retrieve an answer to a user's question. Cortex 306 may also be configured to electronically communicate with LLM-based application 328 to retrieve an answer to a user's question.

LLM-based application 328 may include more robust capabilities than classifier-based application 308. Specifically, LLM-based application 328 may be able to correctly understand longer, less direct and usually less common input. To convert the capabilities, training data and information included in classifier-based application 308 to LLM-based application 328, cortex 306 may convert one or more of intents 310, entities 312 and concepts 314 into a vectorized record. As such, LLM-based application 328 may include vectorized records, or vectors, while classifier-based application 308 may include tables.

Question 302 may be input to cortex 306. Question 302 may be categorized as input. Cortex 306 may convert question 302 into a vector (also referred to as a question vector). Cortex 306 may forward question 302 and/or the question vector to LLM-based application 328. Upon receipt of question 302 and/or the question vector, LLM-based application 328 may execute a vector similarity search on the intent of the question, as shown at 318.

Vector similarity search 318 may compare the question vector to other vectors included within LLM-based application 328. Specifically, vector similarity search 318 may compare the question vector to vectors, which are included in LLM-based application 328, generated from intent tables. Vector similarity search 318 may identify a plurality of vectors that correspond to the question vector. Vector similarity search 318 may select a predetermined number of vectors from the identified vectors. The predetermined number of vectors may be similar, over a threshold level of similarity, to the question vector. The predetermined number of vectors may have scored a higher threshold of similarity to the question vector than the other identified vectors. The predetermined number of vectors may correspond to a predetermined number of intents.

LLM-based application 328 may also execute a vector similarity search on the entity of the question, as shown at 320. Vector similarity search 320 may compare the question vector to the other vectors included within LLM-based application 328. Specifically, vector similarity search 320 may compare the question vector to vectors, which are included in LLM-based application 328, generated from the entity tables. Vector similarity search 320 may identify a plurality of vectors that correspond to the question vector. Vector similarity search 320 may select a predetermined number of vectors from the identified vectors. The predetermined number of vectors may be similar, over a threshold level of similarity, to the question vector. The predetermined number of vectors may have scored a higher threshold of similarity to the question vector than the other identified vectors. The predetermined number of vectors may correspond to a predetermined number of entities.

LLM-based application 328 may execute noise reduction on a list including the predetermined number of intents and the predetermined number of entities, as shown at 322. The noise reduction process may include identifying concepts for each item (including the predetermined number of intents and the predetermined number of entities) included in the list. The noise reduction process may include removing intents and/or entities that do not share a concept with the remaining items on the list. As such, the noise reduction process may remove extraneous information, including entities and items from the list.

LLM-based application 328 may create a prompt, also referred to as a natural language prompt, as shown at 324. The natural language prompt may be for inputting into LLM 326. The natural language prompt may include information for processing by LLM 326. The natural language prompt may conform to a LLM processing technique referred to as few-shot learning.

The natural language prompt conforming to the few-shot learning technique, may include each of the intents and/or entities included in the list, after the list has been reduce by noise reduction process 322. The natural language prompt may also include an example for each of the intents and/or entities included in the list. The examples may be retrieved from training data stored within classifier model-based application 308. The examples may be retrieved from training data stored within cortex 306. The examples may be retrieved from training data stored within LLM-based application 328. The natural language prompt may also include the language included in user question 302. The natural language prompt may also include a set of instructions. The set of instructions may instruct LLM 326 regarding the selection of the intents and/or entities. As such, the set of instructions may instruct LLM 326 to select a single most appropriate intent and/or associated one or more entities from the natural language prompt.

In response to receipt of the natural language prompt, LLM 326 may process the natural language prompt and produce output 304. Output 304 may include a single intent that corresponds to the input as well as one or more entities that correspond to the input.

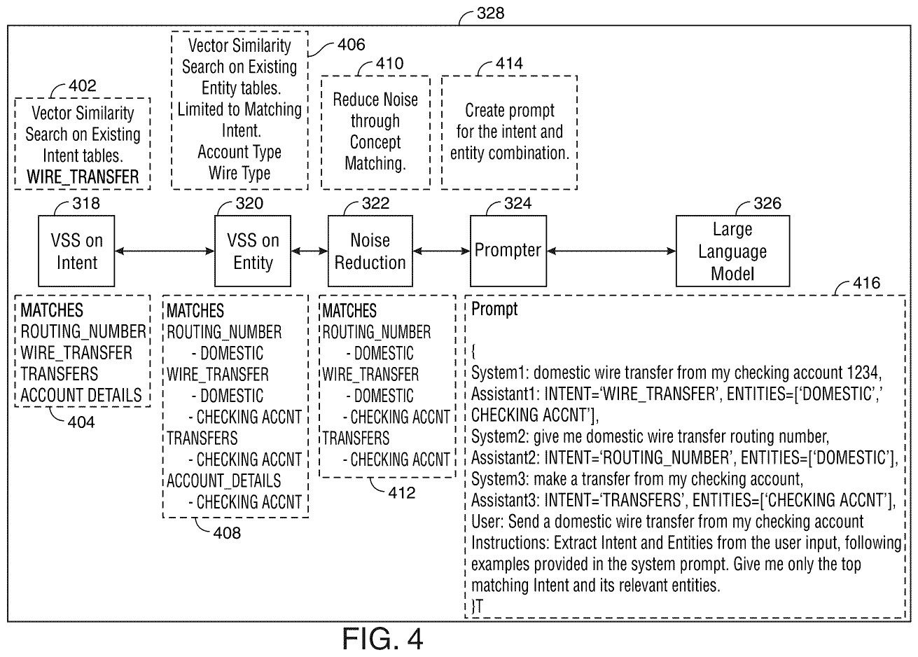

FIG. 4 shows an illustrative diagram. The illustrative diagram shows a detailed view of LLM-based application 328, which may have received input 302 shown in FIG. 3. As shown at 402, VSS on intent 318 may execute a vector similarity search on existing intent tables, which may include one or more intents that have been converted to vectors. As shown at 404, matches to Wire transfer may include Routing number, Wire transfer, Transfers and Account Details.

As shown at 406, VSS on entity 320 may execute a vector similarity search on existing entity tables, which may include one or more entities that have been converted to vectors. The selected entity tables may be limited to entity tables with a matching intent. The matching intent may match the previously identified tables at 318. As shown at 408, matches to Account type and Wire type may include Routing number (domestic), Wire transfer (domestic and checking account), Transfers (checking account) and Account details (checking account). It should be noted that the list of matches 408 includes the list of matches shown at 404 and has been expanded to include additional entities.

As shown at 410, noise reduction process 322 may reduce noise through concept matching, as shown at 410. As shown at 412, the list of matches shown at 408 has been reduced via the noise reduction through concept matching. Specifically, the Account Details intent and the associated Checking Account entity may have been removed from the list of matches shown at 408.

As shown at 414, prompter 324 may create prompt 416 for the intent and entity combination. Prompt 416 may include the intents and associated entities included in list 412, the text included in the user question, and instructions to the LLM. It should be noted that System1 may correspond to an example of the intent and entities referred to at Assistant1, System2 may correspond to an example of the intent and entities referred to at Assistant2, System3 may correspond to an example of the intent and entities referred to at Assistant3, User may correspond to the language included in the user query and Instructions may correspond to system instructions to be processed by LLM 326.

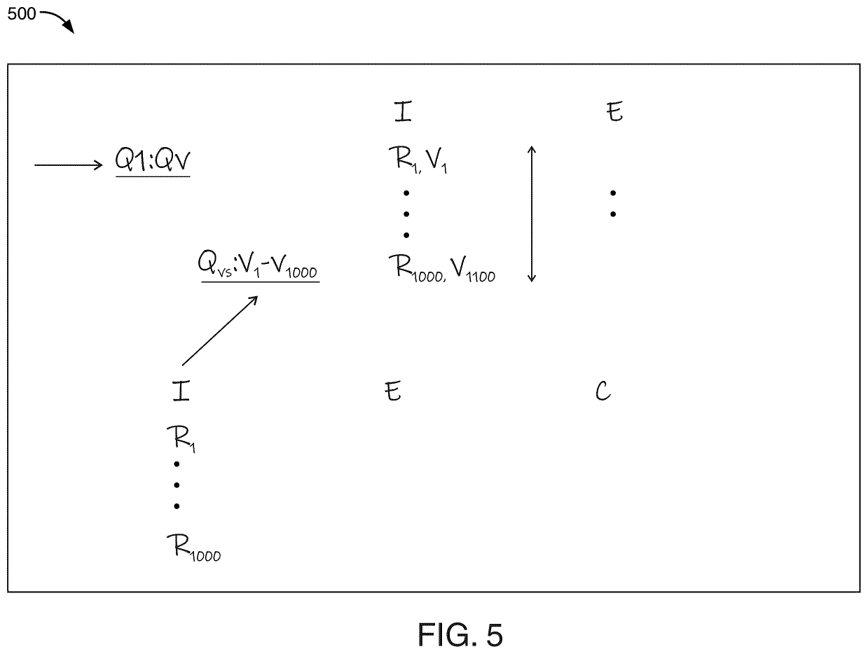

FIG. 5 shows an illustrative diagram. Diagram 500 shows I, E and C on the lower half of the diagram. The lower half of the diagram corresponds to the classifier model-based application. I may correspond to intents; E may correspond to entities and C may correspond to concepts. Each of I, E and C may include multiple records, as indicated by R1 through R1000, shown directly below I on the lower half of the diagram.

Each of the records included in I, E and C may be converted to vectors as indicated by the arrow from I, shown at the lower half of the diagram, to Qvs:V1 through V1000, shown at the upper half of the diagram. The upper half of the diagram may correspond to the LLM-based application. The LLM-based application may store record vectors that correspond to intents (intent records), as indicated by the R1,V1 through R1000, directly beneath I on the upper half of the diagram. The LLM-based application may also store vectors that correspond to entities (entity records), as shown by the dots beneath E on the upper half of the diagram. It should be noted that that the concepts including multiple vectors (not shown) may also be converted to records (concept records) and included in the LLM-based application.

User questions, such as Q1:QV may be input to the LLM-based application, as indicated by Q1:QV shown at the upper half of the diagram. These questions may be converted to vectors and then compared to the stored vector records within the LLM-based application. The vector similarity search on intents may compare the question vector to the records included directly beneath the I on the upper half of the diagram. The vector similarity search of entities may compare the question vector to the records included directly beneath the E on the upper half of the diagram.

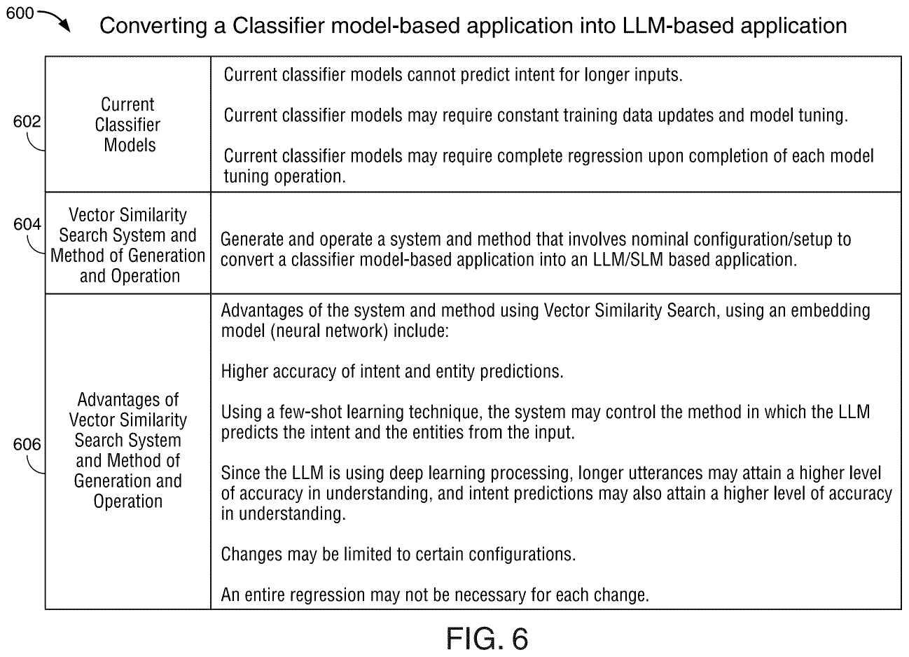

FIG. 6 shows an illustrative diagram. Diagram 600 shows converting a classifier model-based application into an LLM-based application. Current classifier models and details relating to current classifier models may be shown at 602. Current classifier models cannot accurately predict intents for longer inputs. Current classifier models may require constant training data updates and model tuning. Current classifier models may require complete regression upon completion of each model tuning operation.

Vector similarity search system and methods of generation and operation may be shown at 604. Vector similarity search system and methods of generation and operation may include generating and operating a system that method that involves nominal configuration and/or setup to convert a classifier model-based application to a large language model/small language model-based application. A small language model (“SLM”) may be technically structured to resemble a large language model, however a small language model may be domain specific and/or achieve greater levels of efficiency.

Advantages of vector similarity search system and method of generation and operation may be shown at 606. The advantages of the system and method using vector similarity search using an embedding model, such as a neural network may include the following: higher accuracy of intent and entity predictions; using the few-shot learning technique, the system controls the method in which the LLM predicts the intent and the entities from the input; since the system is using deep learning processing, longer utterances may attain a higher level of accuracy in understanding, and intent predictions may also attain a higher level of understanding; changes may be limited to certain configurations; and an entire regression is not necessary for each change.

Thus, methods and apparatus for a CLASSIFIER CONVERSION SYSTEM are provided. Persons skilled in the art will appreciate that the present disclosure can be practiced by other than the described embodiments, which are presented for purposes of illustration rather than of limitation and that the present disclosure is limited only by the claims that follow.

What is claimed is:

1. A method for converting a classifier model application into a large language model application, the method comprising:
executing an offline process operating on a hardware processor and a hardware memory, the offline process comprising:
retrieving existing tables from an existing training database, said existing tables comprising a plurality of intents, a plurality of entities and a plurality of concepts; and
converting, into a vectorized record:
each intent included in the plurality of intents;
each entity included in the plurality of entities; and
each concept, included in the plurality of concepts, into a vectorized record; and
inputting each vectorized record into a database linked to the large language model application;
executing an online process operating on the hardware processor and the hardware memory, said online process being executed in real-time, said online process comprising:
receiving a question from a user;
converting the question into a question vector;
executing a first vector similarity search on the question vector, said first vector similarity search comparing the question vector to a first portion of the vectorized records, said first portion of the vectorized records corresponding to the plurality of intents;
generating an empty list of vectorized records that are similar, over a threshold level of similarity, to the question vector;
selecting, for inclusion in the list of vectorized records, a first set of vectorized records, said first set of vectorized records comprising a first predetermined number of vectorized records selected from the first portion of vectorized records, said first portion of vectorized records corresponding to one or more intents, included in the plurality of intents, that are most similar to the question vector;
inserting the first set of vectorized records into the list of vectorized records;
executing a second vector similarity search on the question vector, said second vector similarity search comparing the question vector to a second portion of the vectorized records, said second portion of the vectorized records corresponding to the plurality of entities;
selecting, for inclusion in the list of vectorized records, a second set of vectorized records, said second set of vectorized records comprising a second predetermined number of vectorized records selected from the second portion of vectorized records, said second portion of vectorized records corresponding to one or more entities, included in the plurality of entities, that are most similar to the question vector;
inserting the second set of vectorized records into the list of vectorized records;
executing a noise reduction process on the list of vectorized records;
creating a natural language prompt to be input into a large language model, said natural language prompt comprising the list of vectorized records;
inputting the natural language prompt to the large language model; and
outputting, from the large language model, a selected vectorized record from the list of vectorized records.

2. The method of claim 1 wherein the noise reduction process comprises concept matching.

3. The method of claim 1 wherein the noise reduction process comprises removing intents and/or entities that do correlate, over a threshold level of correlation, to the remaining intents within the list of vectorized records.

4. The method of claim 1 wherein the natural language prompt further comprises:
an example for each vectorized record included in the list of vectorized records;
the question; and
a request for a best matching intent and one or more relevant entities from the list of vectorized records.

5. The method of claim 1 wherein the natural language prompt is created to query the large language model using a few-shot learning technique.

6. A system for converting a classifier model-based application into a large language model-based application, the system comprising:
a hardware processor and a hardware memory operable to execute:
an offline process, said offline process operable to:
retrieve existing tables comprising one or more intents from an existing training database;
convert each of the existing tables comprising one or more intents into a vectorized record corresponding to an intent;
retrieve existing tables comprising one or more entities from an existing training database;
convert each of the existing tables comprising one or more entities into a vectorized record corresponding to an entity; and
input the vectorized records corresponding to one or more intents and the vectorized records corresponding to one or more entities into a database linked to the LLM-based application;
a real-time process, said real-time process operable to:
electronically receive a question from a user;
convert the question into a question vector;
execute a first vector similarity search on the question vector, the first vector similarity search compares the question vector to the vectorized records corresponding to one or more intents stored within the database;
generate an empty list data structure operable to hold a plurality of vectorized records;
select a first set of vectorized records, said first set of vectorized records comprising a predetermined number of vectorized records corresponding to one or more intents that are similar, over a first threshold level of similarity, to the question vector;
append the first set of vectorized records to the list of vectorized records;
execute a second vector similarity search on the question vector, the second vector similarity search compares the question vector to the vectorized records corresponding to one or more entities stored within the database linked to the LLM-based application;
select a second set of vectorized records, said second set of vectorized records comprising a predetermined number of vectorized records corresponding to one or more entities that are similar, over a second threshold level of similarity, to the question vector;
append the second set of vectorized records to the list of vectorized records;
execute a noise reduction process on the list of vectorized records;
create a prompt to be input into a large language model, said prompt comprising the list of vectorized records;
input the prompt into the large language model; and
receive a selection, from the large language model, of a vectorized record from the list of vectorized records;
identify a response, at the large language model, for the question, said response based on an identified intent and/or entity of the question being an intent and/or entity that corresponds to the vectorized record;
electronically transmit the response to the user.

7. The system of claim 6 wherein the noise reduction process comprises concept matching.

8. The system of claim 6 wherein the noise reduction process comprises removal of intents and/or entities that correlate, over a threshold level of correlation, with a remainder of intents within the list of vectorized records.

9. The system of claim 6 wherein the prompt further comprises:
an example for each vectorized record included in the list of vectorized records;
the question; and
a request for a most appropriate matching intent and one or more relevant entities from the list of vectorized records.

10. The system of claim 6 wherein the prompt queries the large language model using a few-shot learning technique.

11. A method for converting a classifier model-based application into a large language model-based application, the method comprising:
executing a preprocessing process operating on a hardware processor and a hardware memory, the preprocessing process comprising:
retrieving one or more existing tables comprising intents and entities from a database operating at the classifier model-based application; and
converting each of the existing tables into a vectorized record; and
inputting each vectorized record into a database linked to the large language model-based application;
executing a production process operating on the hardware processor and the hardware memory, said production process being executed in real-time in response to user questions, said production process comprising:
receiving a question from a user;
converting the question into a question vector;
executing a first vector similarity search on the question vector, said first vector similarity search comparing the question vector to the vectorized records corresponding to intents stored within the database linked to the large language model-based application;
selecting a first predetermined number of vectorized records corresponding to intents that are similar, over a first threshold level of similarity, to the question vector;
generating a list of vectorized records comprising the selected vectorized records;
executing a second vector similarity search on the question vector, said second vector similarity search comparing the question vector to the vectorized records corresponding to entities stored within the database linked to the large language model-based application;
selecting a second predetermined number of vectorized records corresponding to entities that are similar, over a second threshold level of similarity, to the question vector;
appending the second predetermined number of vectorized records to the list of vectorized records;
performing a noise reduction process on the list of vectorized records;
creating a prompt to be input into a large language model, said prompt comprising the list of vectorized records;
inputting the prompt to the large language model; and
receiving, from the large language model, a selection of a vectorized record from the list of vectorized records.

12. The method of claim 11 wherein the noise reduction process comprises concept matching.

13. The method of claim 11 wherein the noise reduction process comprises removing intents and/or entities that do correlate, over a threshold level of correlation, with the remaining intents and/or entities within the list of vectorized records.

14. The method of claim 11 wherein the prompt further comprises:
an example for each vectorized record included in the list of vectorized records;
the question; and
a request for a vectorized record that corresponds to an intent, the vectorized record having a greater level of correspondence to the question than the remaining vectorized records within the list of vectorized records.

15. The method of claim 11 wherein the prompt is created to query the large language model using a few-shot learning technique.

16. A system for converting a classifier model-based application into a large language model-based application, the system comprising:
a hardware processor and a hardware memory operable to execute:
a preprocessing process, said preprocessing process operable to:
retrieve existing tables comprising intents from an existing training database;
convert each of the existing tables comprising intents into a vectorized record corresponding to an intent;
retrieve existing tables comprising entities from an existing training database;
convert each of the existing tables comprising entities into a vectorized record corresponding to an entity; and
input the vectorized records corresponding to intents and the vectorized records corresponding to entities into a database linked to the large language model-based application;
a real-time process, said real-time process operable to:
electronically receive a question from a user;
convert the question into a question vector;
execute a first vector similarity search on the question vector, the first vector similarity search compares the question vector to the vectorized records corresponding to intents stored within the database linked to the large language model-based application;
select a first set of vectorized records, said first set of vectorized records comprising a predetermined number of vectorized records corresponding to intents that are similar, over a first threshold level of similarity, to the question vector;
generate a list of vectorized records comprising the first set of vectorized records to the list of vectorized records;
execute a second vector similarity search on the question vector, the second vector similarity search compares the question vector to the vectorized records corresponding to entities stored within the database linked to the large language model-based application;
select a second set of vectorized records, said second set of vectorized records comprising a predetermined number of vectorized records corresponding to entities that are similar, over a second threshold level of similarity, to the question vector;
append the second set of vectorized records to the list of vectorized records;
execute a noise reduction process on the list of vectorized records;
create a prompt to be input into a large language model, said prompt comprising the list of vectorized records;
input the prompt into the large language model; and
receive a selection of a vectorized record from the list of vectorized records;
identify an intent and/or entity that corresponds to the selection of the vectorized record; and
generate a response to the question based on the identified intent and/or entity that corresponds to the selection of the vectorized record; and
electronically transmit the response to the user.

17. The system of claim 16 wherein the noise reduction process comprises concept matching.

18. The system of claim 16 wherein the noise reduction process comprises removal of intents and/or entities that correlate, over a threshold level of correlation, with a remainder of intents within the list of vectorized records.

19. The system of claim 16 wherein the prompt further comprises:
an example for each vectorized record included in the list of vectorized records;
the question; and
a request for a best matching intent and one or more associated entities from the list of vectorized records.

20. The system of claim 16 wherein the prompt queries the large language model using a few-shot learning technique.
